(19) United States
(12) Patent Application Publication
(10) Pub. No.: US 2025/0349243 A1
(43) Pub. Date: Nov. 13, 2025

(54) DISPLAY DEVICE AND ELECTRONIC DEVICE INCLUDING THE DISPLAY DEVICE

(71) Applicant: Samsung Display Co., LTD., Yongin-si (KR)

(72) Inventor: Gi Chang LEE, Yongin-si (KR)

(21) Appl. No.: 19/027,454

(22) Filed: Jan. 17, 2025

(30) Foreign Application Priority Data
May 10, 2024 (KR) 10-2024-0061842

(51) Int. Cl. G09G 3/32

(52) U.S. Cl. CPC G09G 3/32; G09G 2310/027; G09G 2310/0286; G09G 2330/021; G09G 2330/028

(57) ABSTRACT

A display device according to embodiments of the present invention includes a controller configured to generate a start signal and a clock signal, a masking circuit configured to generate output clock signals by masking at least a portion of the clock signal, and a plurality of stages configured to receive an output clock signal of the output clock signals in response to the start signal and output a data signal. The masking circuit is configured to receive data signals respectively output from a stage of the plurality of stages and at least one other stage disposed adjacent to the stage.

This application claims priority to Korean Patent Application No. 10-2024-0061842, filed on May 10, 2024, and all the benefits accruing therefrom under 35 U.S.C. § 119, the content of which in its entirety is herein incorporated by reference.

### BACKGROUND

### Field

The present disclosure relates to a display device and an electronic device including the display device.

### Discussion

A display device includes a data driver for supplying a data signal to data lines, a gate driver for supplying a gate signal to gate lines, and pixels arranged to be connected to the data lines and the gate lines.

In this case, the data driver may include shift registers for generating the data signal. The shift registers may include at least one transistor, and the transistor may be turned on and/or turned off by a clock signal supplied to the shift registers and power may be consumed.

The above description is intended to help understand the background technology of the technical ideas of the present invention. Therefore, it cannot be understood as content corresponding to prior art known to those skilled in the art to which the present invention pertains.

### SUMMARY

An object of the present invention is to provide a display device that can minimize unintentionally wasted power consumption by masking at least a portion of a clock signal supplied to shift registers, and an electronic device including the display device.

An aspect of the present invention relates to a display device. A display device according to embodiments of the present invention includes a controller configured to generate a start signal and a clock signal; a masking circuit configured to generate output clock signals by masking at least a portion of the clock signal; and a plurality of stages configured to receive an output clock signal of the output clock signals in response to the start signal and output a data signal. The masking circuit is configured to receive data signals respectively output from a stage of the plurality of stages and at least one other stage disposed adjacent to the stage.

The plurality of stages may include a first stage and a second stage following the first stage, and the masking circuit may include a first masking circuit configured to receive the start signal, a first data signal output from the first stage, and a second data signal output from the second stage.

The first masking circuit may be configured to supply a first output clock signal to the first stage, and supply a second output clock signal different from the first output clock signal to the second stage.

The first masking circuit may be configured to supply the first output clock signal by refraining from masking the clock signal during a third section, and supply the second output clock signal by masking the clock signal during sections different from the third section.

The first masking circuit may be configured to supply the second output clock signal by inverting a phase of the first output clock signal during the third section, such that second output clock signal may have a waveform in which the phase of the first output clock signal during the third section is inverted.

The third section may be from a first time point at which the start signal transitions from a logic low level to a logic high level to a fifth time point at which the second data signal transitions from the logic high level to the logic low level.

The clock signal may have a cycle duration equal to a duration of a first section, and the clock signal may alternate between a logic high level and a logic low level at each cycle duration.

The plurality of stages may include an i-th stage, an (i−1)th stage preceding the i-th stage, and an (i+1)th stage following the i-th stage, and the masking circuit may include an i-th masking circuit configured to receive an (i−1)th data signal output from the (i−1)th stage, an i-th data signal output from the i-th stage, and an (i+1)th data signal output from the (i+1)th stage.

The i-th masking circuit may be configured to supply an i-th output clock signal to the i-th stage, and supply an (i+1)th output clock signal different from the i-th output clock signal to the (i+1)th stage.

The i-th masking circuit may be configured to supply the i-th output clock signal by refraining from masking the clock signal during a fourth section, and supply the i-th output clock signal by masking the clock signal during sections different from the fourth section, and the (i+1)th masking circuit may be configured to supply the (i+1)th output clock signal by inverting a phase of the i-th output clock signal during the fourth section, such that the (i+1)th output clock signal may have a waveform in which the phase of the i-th output clock signal during the fourth section is inverted.

The fourth section may be from a first time point at which the i-th data signal transitions from a logic low level to a logic high level to a fifth time point at which the (i+1)th data signal transitions from the logic high level to the logic low level.

The plurality of stages may include an (n−1)th stage and an n-th stage following the (n−1)th stage, and the masking circuit may include an n-th masking circuit configured to receive the start signal, an (n−1)th data signal output from the (n−1)th stage, and an n-th data signal output from the n-th stage.

The n-th masking circuit may be configured to supply an n-th output clock signal to the n-th stage by refraining from masking the clock signal during a fifth section, and supply an (n+1)th output clock signal by masking the clock signal during sections different from the fifth section.

The fifth section may be from a first time point at which the (n−1)th data signal transitions from a logic low level to a logic high level to a fifth time point at which the n-th data signal transitions from the logic high level to the logic low level.

The masking circuit may include a logic operation unit configured to receive an (i−1)th data signal, an i-th data signal, and an (i+1)th data signal; a first inverter including an input terminal connected to a first node; a first transistor including an electrode configured to receive a voltage from a first power source, another electrode connected to an output terminal of the logic operation unit, and a gate electrode configured to receive a reset signal; an N-type second transistor including an electrode connected to a third node configured to receive the clock signal, another electrode connected to a fourth node, and a gate electrode connected to an output terminal of the first inverter; and a P-type third transistor including an electrode connected to the third node, another electrode connected to the fourth node, and a gate electrode connected to the first node,

The masking circuit may further include a fourth transistor including an electrode connected to a second power source having a lower voltage level than the first power source, another electrode connected to the fourth node, and a gate electrode connected to a second node, and when the first inverter outputs a signal of a logic low level, the fourth node may receive a voltage from the second power source.

The masking circuit may further include a second inverter including an input terminal connected to the fourth node, and when the first inverter outputs a signal of a logic high level, the second inverter may output an i-th inverted output clock signal by inverting a phase of an i-th output clock signal output through the fourth node.

The masking circuit may be configured to supply the i-th output clock signal to an i-th stage outputting the i-th data signal and included in the plurality of stages, and supply the i-th inverted output clock signal to an (i+1)th stage outputting the (i+1)th data signal and included in the plurality of stages.

The logical operation unit may include a NOR gate.

Another aspect of the present invention relates to an electronic device. An electronic device according to embodiments of the present invention includes a display device configured to display an image based on input image data; and a processor configured to provide the input image data to the display device. The display device may include a controller configured to generate a start signal and a clock signal; a masking circuit configured to generate output clock signals by masking at least a portion of the clock signal; and a plurality of stages configured to receive an output clock signal of the output clock signals in response to the start signal and output a data signal. The masking circuit is configured to receive data signals respectively output from a stage of the plurality of stages and at least one other stage disposed adjacent to the stage.

### BRIEF DESCRIPTION OF THE DRAWINGS

The accompanying drawings, which are included to provide a further understanding of the inventive concepts, and are incorporated in and constitute a part of this specification, illustrate example embodiments of the inventive concepts, and, together with the description, serve to explain principles of the inventive concepts.

FIG. 1 is a block diagram illustrating an embodiment of a display device.

FIG. 2 is a block diagram illustrating an embodiment of any one of sub-pixels of FIG. 1.

FIG. 3 is a diagram illustrating an embodiment of components of a data driver of FIG. 1.

FIG. 4 is a block diagram schematically illustrating a comparative example of the data driver of FIG. 3.

FIG. 5 is a block diagram schematically illustrating an embodiment of the data driver of FIG. 3.

FIG. 6 is a diagram illustrating an embodiment of connection terminals of a stage and a masking circuit illustrated in FIG. 5.

FIGS. 7A to 7C are diagrams illustrating an embodiment of a method of driving the data driver of FIG. 5.

FIG. 8 is a diagram illustrating components of a (2i−1)th masking circuit of FIG. 6.

FIG. 9 is a circuit diagram illustrating components of an i-th stage and an (i+1)th stage of FIG. 6.

FIG. 10 is a block diagram illustrating an embodiment of a display system.

FIGS. 11 to 14 are perspective views illustrating application examples of the display system of FIG. 10.

### DETAILED DESCRIPTION

Hereinafter, example embodiments of the present invention will be described in more detail with reference to the accompanying drawings. It should be noted that in the following description, parts supportive of understanding the operation according to the present invention will be described, and descriptions of other parts will be omitted in order to not obscure the gist of the present invention. In some aspects, the present invention is not limited to the embodiments described herein and may be embodied in other forms. The embodiments described herein are provided to explain in detail enough to enable those skilled in the art to easily implement the technical idea of the present invention.

Throughout the specification, in a case where a portion is “connected” to another portion, the case includes not only a case where the portion is “directly connected” but also a case where the portion is “indirectly connected” with another element interposed therebetween. Terms used herein are for describing specific embodiments and are not intended to limit the present invention. Throughout the specification, in a case where a certain portion “includes”, the case means that the portion may further include another component without excluding another component unless otherwise stated. “At least any one of X, Y, and Z” and “at least any one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

Here, terms such as, for example, first and second may be used to describe various components, but these components are not limited to these terms. These terms are used to distinguish one component from another component. Therefore, a first component may refer to a second component within a range without departing from the scope disclosed herein.

Spatially relative terms such as, for example, “under”, “on”, and the like may be used for descriptive purposes, thereby describing the relationship between one element or feature and another element(s) or feature(s) as illustrated in the drawings. Spatially relative terms are intended to include other directions in use, in operation, and/or in manufacturing, in addition to the direction depicted in the drawings. In an example in which a device illustrated in the drawing is turned upside down, elements depicted as being positioned “under” other elements or features are positioned in a direction “on” the other elements or features. Therefore, in an embodiment, the term “under” may include both directions of on and under. In some aspects, the device may face in other directions (for example, rotated 90 degrees or in other directions) and thus the spatially relative terms used herein are interpreted according thereto.

Various embodiments are described with reference to drawings schematically illustrating example embodiments. Accordingly, it will be expected that shapes may vary, for example, according to tolerances and/or manufacturing techniques. Therefore, the embodiments disclosed herein cannot be construed as being limited to illustrated specific shapes, and should be interpreted as including, for example, changes in shapes that occur as a result of manufacturing. As described herein, the shapes illustrated in the drawings may not show actual shapes of areas of a device, and the present embodiments are not limited thereto.

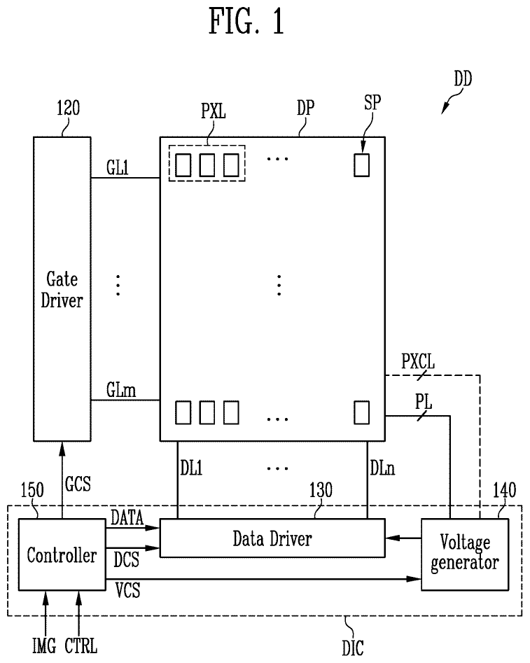

FIG. 1 is a block diagram illustrating an embodiment of a display device.

Referring to FIG. 1, a display device DD may include a display panel DP, a gate driver 120, a data driver 130, a voltage generator 140, and a controller 150.

The display panel DP may include sub-pixels SP. The sub-pixels SP may be connected to the gate driver 120 through first to m-th gate lines GL1 to GLm. The sub-pixels SP may be connected to the data driver 130 through first to n-th data lines DL1 to DLn.

The sub-pixels SP may generate light of two or more colors. For example, each of the sub-pixels SP may generate light of a color such as, for example, red, green, blue, cyan, magenta, or yellow.

Two or more sub-pixels among the sub-pixels SP may constitute one pixel PXL. For example, the pixel PXL may include three sub-pixels as illustrated in FIG. 1. As such, the pixel PXL may emit light of various colors and various luminances depending on the combination of light emitted from the sub-pixels included in the pixel PXL.

The gate driver 120 may be connected to sub-pixels SP arranged in a row direction through the first to m-th gate lines GL1 to GLm. The gate driver 120 may output gate signals to the first to m-th gate lines GL1 to GLm in response to a gate control signal GCS. In some embodiments, the gate control signal GCS may include a start signal indicating the start of each frame, a horizontal synchronization signal, and the like.

The gate driver 120 may be disposed on one side of the display panel DP. However, embodiments of the present invention are not limited thereto. For example, the gate driver 120 may be divided into two or more physically and/or logically separated drivers, and such drivers may be disposed on one side of the display panel DP and on the other side of the display panel DP opposite the one side. As such, the gate driver 120 may be disposed around the display panel DP in various forms depending on embodiments.

The data driver 130 may be connected to sub-pixels SP arranged in a column direction through the first to n-th data lines DL1 to DLn. The data driver 130 may receive image data DATA and a data control signal DCS from the controller 150. The data driver 130 may operate in response to the data control signal DCS. In some embodiments, the data control signal DCS may include a source start signal, a source shift clock, a source output enable signal, and the like.

The data driver 130 may receive voltages from the voltage generator 140. The data driver 130 may generate data signals having grayscale voltages corresponding to the image data DATA using the received voltages, and apply the data signals to the first to n-th data lines DL1 to DLn. In an example in which a gate signal is applied to each of the first to m-th gate lines GL1 to GLm, the data signals corresponding to the image data DATA may be applied to the data lines DL1 to DLn. Accordingly, the sub-pixels SP may generate light corresponding to the data signals, and the display panel DP may display an image.

In some embodiments, the gate driver 120 and data driver 130 may include complementary metal-oxide semiconductor (CMOS) circuit elements.

The voltage generator 140 may operate in response to a voltage control signal VCS from the controller 150. The voltage generator 140 may be configured to generate a plurality of voltages and provide the generated voltages to components of the display device DD, such as, for example, the gate driver 120, the data driver 130, and the controller 150. The voltage generator 140 may generate the plurality of voltages by regulating an input voltage received by the voltage generator 140 from outside the display device DD.

The voltage generator 140 may generate a first power source voltage and a second power source voltage. The generated first and second power source voltages may be provided to the sub-pixels SP through power source lines PL. In other embodiments, at least one of the first and second power source voltages may be provided from outside the display device DD.

In some aspects, the voltage generator 140 may provide various voltages and/or signals. For example, the voltage generator 140 may provide one or more initialization voltages to be applied to the sub-pixels SP. For example, during a sensing operation to sense the electrical characteristics of transistors and/or light emitting elements of the sub-pixels SP, a predetermined reference voltage may be applied to the first to n-th data lines DL1 to DLn, and the voltage generator 140 may generate the reference voltage and transmit the reference voltage to the data driver 130. For example, during a display operation to display an image on the display panel DP, common pixel control signals may be applied to the sub-pixels SP, and the voltage generator 140 may generate the pixel control signals. In some embodiments, the voltage generator 140 may provide the pixel control signals to the sub-pixels SP through pixel control lines PXCL. FIG. 1 illustrates an embodiment in which the pixel control lines PXCL are connected between the voltage generator 140 and the display panel DP, but embodiments of the present invention are not limited thereto. For example, the pixel control lines PXCL may be connected between the gate driver 120 and the display panel DP. In this case, the pixel control signals may be transmitted from the voltage generator 140 to the pixel control lines PXCL through the gate driver 120.

The controller 150 may control various operations of the display device DD. The controller 150 may receive input image data IMG and a control signal CTRL corresponding thereto from the outside. The controller 150 may provide the gate control signal GCS, the data control signal DCS, and the voltage control signal VCS in response to the control signal CTRL.

The controller 150 may convert the input image data IMG to suit the display device DD or the display panel DP and output the image data DATA. In some embodiments, the controller 150 may output the image data DATA by aligning the input image data IMG to suit the sub-pixels SP in row units.

Two or more components of the data driver 130, the voltage generator 140, and the controller 150 may be mounted on one integrated circuit. As illustrated in FIG. 1, the data driver 130, the voltage generator 140, and the controller 150 may be included in a driver integrated circuit DIC. In this case, the data driver 130, the voltage generator 140, and the controller 150 may be functionally separate components within a single driver integrated circuit DIC. In other embodiments, at least one of the data driver 130, the voltage generator 140, and the controller 150 may be provided as a separate component from the driver integrated circuit DIC.

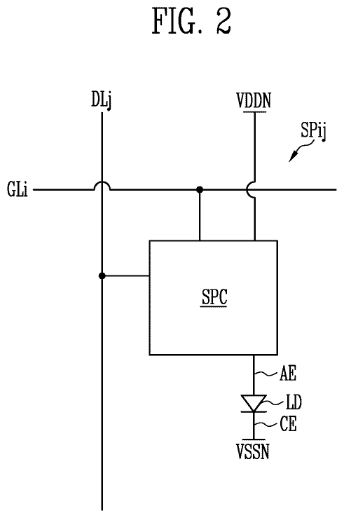

FIG. 2 is a block diagram illustrating an embodiment of any one of sub-pixels of FIG. 1. In FIG. 2, a sub-pixel SPij arranged in an i-th row (i may be an integer greater than or equal to 1 and less than or equal to m) and a j-th column (j may be an integer greater than or equal to 1 and less than or equal to n) among the sub-pixels SP in FIG. 1 is illustrated as an example.

Referring to FIG. 2, the sub-pixel SPij may include a sub-pixel circuit SPC and a light emitting element LD.

The light emitting element LD may be connected between a first power source voltage node VDDN and a second power source voltage node VSSN. The first power source voltage node VDDN may be connected to one of the power source lines PL of FIG. 1 to receive the first power source voltage. The second power source voltage node VSSN may be connected to another one of the power source lines PL of FIG. 1 to receive the second power source voltage. The first power source voltage (also referred to herein as a voltage from the first power source voltage node VDDN) may have a higher voltage level than the second power source voltage (also referred to herein as a voltage from the second power source voltage node VSSN).

The light emitting element LD may be connected between an anode electrode AE and a cathode electrode CE. The anode electrode AE may be connected to the first power source voltage node VDDN through the sub-pixel circuit SPC. For example, the anode electrode AE may be connected to the first power source voltage node VDDN through one or more transistors included in the sub-pixel circuit SPC. The cathode electrode CE may be connected to the second power source voltage node VSSN. The light emitting element LD may be configured to emit light according to a current flowing from the anode electrode AE to the cathode electrode CE.

The sub-pixel circuit SPC may be connected to an i-th gate line GLi among the first to m-th gate lines GL1 to GLm of FIG. 1 and a j-th data line DLj among the first to n-th data lines DL1 to DLn of FIG. 1. In response to a gate signal received through the i-th gate line GLi, the sub-pixel circuit SPC may control the light emitting element LD to emit light according to a data signal received through the j-th data line DLj. In some embodiments, the sub-pixel circuit SPC may be further connected to the pixel control lines PXCL of FIG. 1. In this case, the sub-pixel circuit SPC may control the light emitting element LD in response to the pixel control signals received through the pixel control lines PXCL.

For these operations, the sub-pixel circuit SPC may include circuit elements, such as, for example, transistors and one or more capacitors.

The transistors of the sub-pixel circuit SPC may include P-type transistors and/or N-type transistors. In some embodiments, the transistors of the sub-pixel circuit SPC may include metal oxide silicon field effect transistors (MOSFET). In some embodiments, the transistors of the sub-pixel circuit SPC may include an amorphous silicon semiconductor, a monocrystalline silicon semiconductor, a polycrystalline silicon semiconductor, an oxide semiconductor, or the like.

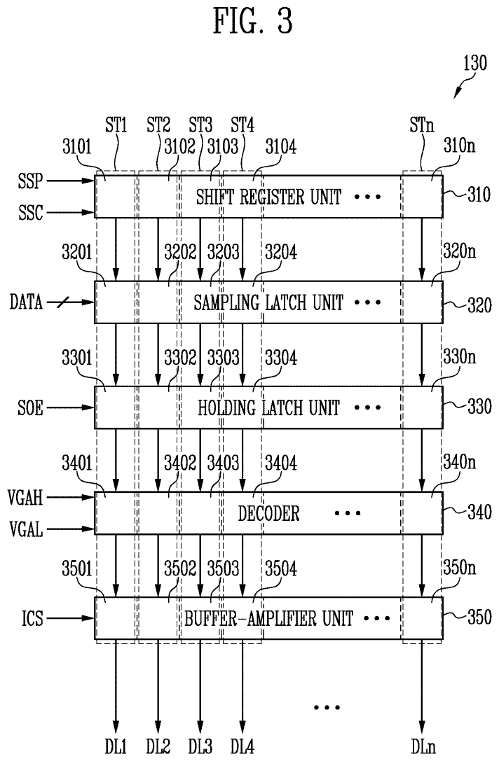

FIG. 3 is a diagram illustrating an embodiment of components of a data driver of FIG. 1. Referring to FIG. 3, the data driver 130 may include a shift register unit 310, a sampling latch unit 320, a holding latch unit 330, a decoder 340, and a buffer-amplifier unit 350.

The shift register unit 310 may sequentially generate n sampling signals in response to a source start pulse SSP and a source shift clock SSC. Specifically, the shift register unit 310 may sequentially generate n sampling signals while shifting the source start pulse SSP for each cycle of the source shift clock SSC. The shift register unit 310 may include n shift registers 3101 to 310n.

The sampling latch unit 320 may sequentially latch (or store) the image data DATA in response to the sampling signals sequentially supplied from the shift register unit 310. The sampling latch unit 320 may include n sampling latches 3201 to 320n configured to store n image data DATA.

The holding latch unit 330 may latch (or store) the image data DATA supplied from the sampling latch unit 320 in response to a source output enable (SOE) signal. The holding latch unit 330 may supply the stored image data DATA to the decoder 340. The holding latch unit 330 may include n holding latches 3301 to 330n.

The decoder 340 may convert the image data DATA output from the holding latch unit 330 into an analog signal (for example, an analog voltage). The decoder 340 may output the converted analog signal to the buffer-amplifier unit 350. The decoder 340 may receive a minimum grayscale gamma voltage VGAL and a maximum grayscale gamma voltage VGAH. The decoder 340 may select grayscale voltages corresponding to the image data DATA input from the holding latch unit 330 based on the input minimum grayscale gamma voltage VGAL and maximum grayscale gamma voltage VGAH. The decoder 340 may include n digital-to-analog converters 3401 to 340n. The decoder 340 may generate n data voltages using the digital-to-analog converters 3401 to 340n disposed corresponding to each channel (for example, each data line), and supply the generated data voltages to the buffer-amplifier unit 350.

The buffer-amplifier unit 350 may supply the n data voltages supplied from the decoder 340 to n data lines DL1 to DLn. The buffer-amplifier unit 350 may include n buffer-amplifiers 3501 to 350n.

The n shift registers 3101 to 310n, the n sampling latches 3201 to 320n, the n holding latches 3301 to 330n, the n digital-to-analog converters 3401 to 340n, and the n buffer-amplifiers 3501 to 350n may be implemented as n stages ST1 to STn. For example, a first shift register 3101, a first sampling latch 3201, a first holding latch 3301, a first digital-to-analog converter 3401, and a first buffer-amplifier 3501 may be implemented as a first stage ST1.

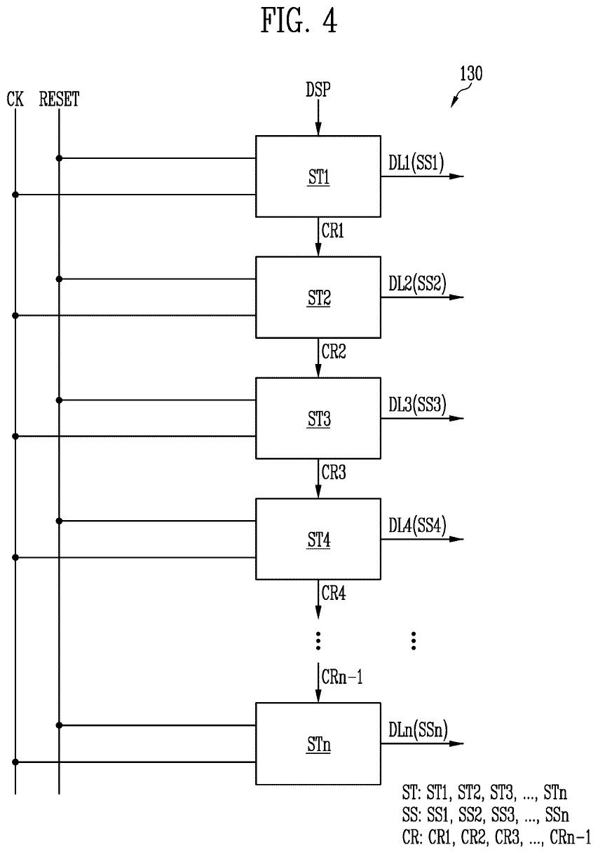

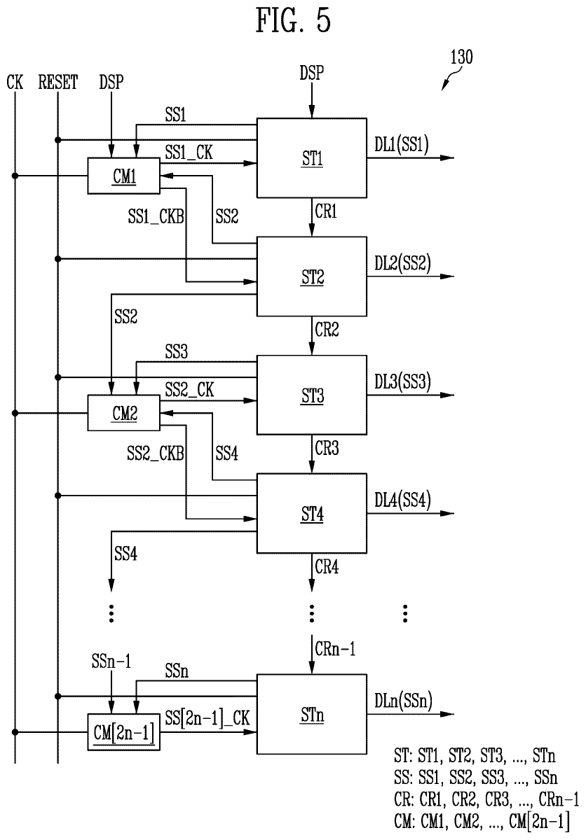

FIG. 4 is a block diagram schematically illustrating a comparative example of the data driver of FIG. 3. FIG. 5 is a block diagram schematically illustrating an embodiment of the data driver of FIG. 3.

Referring to FIGS. 4 and 5, the data driver 130 may include a plurality of stages ST1 to STn. Each of the stages ST1 to STn may be connected to one of the data lines DL1 to DLn, and may output data signals SS and carry signals CR in response to a clock signal CK and a start signal DSP. For example, a third stage ST3 may supply a third data signal SS3 to a third data line DL3.

Referring to FIG. 5, the data driver 130 according to an embodiment of the present invention may include a masking circuit CM connected to two stages ST. For example, a first masking circuit CM1 may be connected to a first stage ST1 and a second stage ST2. Accordingly, the number of masking circuits CM may be 2n−1 corresponding to n stages ST. For example, a (2n−1)th masking circuit CM[2n−1] may be connected to an (n−1)th stage STn−1 and an n-th stage STn.

The masking circuit CM may receive a data signal SS output from at least one stage ST disposed adjacent to a stage ST connected to the masking circuit CM. For example, the first masking circuit CM1 may be connected to the first stage ST1 and the second stage ST2. In this case, the first masking circuit CM1 may receive a first data signal SS1 and a second data signal SS2 output from the first stage ST1 and the second stage ST2. In some aspects, the first masking circuit CM1 may also receive the start signal DSP. In some aspects, a second masking circuit CM2 may be connected to a third stage ST3 and a fourth stage ST4. In this case, the second masking circuit CM2 may receive the second data signal SS2, the third data signal SS3, and a fourth data signal SS4 output from the second stage ST2, the third stage ST3, and the fourth stage ST4, respectively. Furthermore, the (2n−1)th masking circuit CM[2n−1] may be connected to the (n−1)th stage STn−1 and the n-th stage STn. In this case, the (2n−1)th masking circuit CM[2n−1] may receive an (n−1) h data signal and an n-th data signal SSn output from the (n−1)th stage STn−1 and the n-th stage STn, respectively.

In this case, the masking circuit CM may mask at least a portion of the clock signal CK. For example, the first masking circuit CM1 may generate a first output clock signal SS1_CK and a first inverted output clock signal SS1_CKB by masking a portion of the clock signal CK. The first masking circuit CM1 may supply the first output clock signal SS1_CK to the first stage ST1 and the first inverted output clock signal SS1_CKB to the second stage ST2. Here, the first inverted output clock signal SS1_CKB may have a waveform in which the phase of the first output clock signal SS1_CK is inverted in at least some sections.

According to an embodiment, the first output clock signal SS1_CK and the first inverted output clock signal SS1_CKB may also be supplied to the first stage ST1. In some aspects, the first inverted output clock signal SS1_CKB and the first output clock signal SS1_CK may also be supplied to the second stage ST2.

According to a comparative example, the plurality of stages ST may receive the clock signal CK unmasked. Accordingly, even when each of the plurality of stages ST does not output the data signal SS, at least one transistor included in the stages ST may be turned on and/or turned off by the clock signal CK. Accordingly, power consumption may be wasted when driving the display device DD (see FIG. 1).

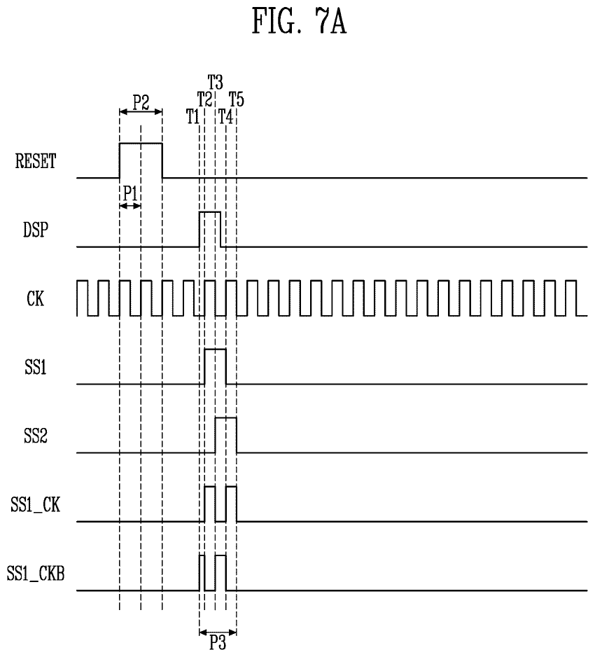

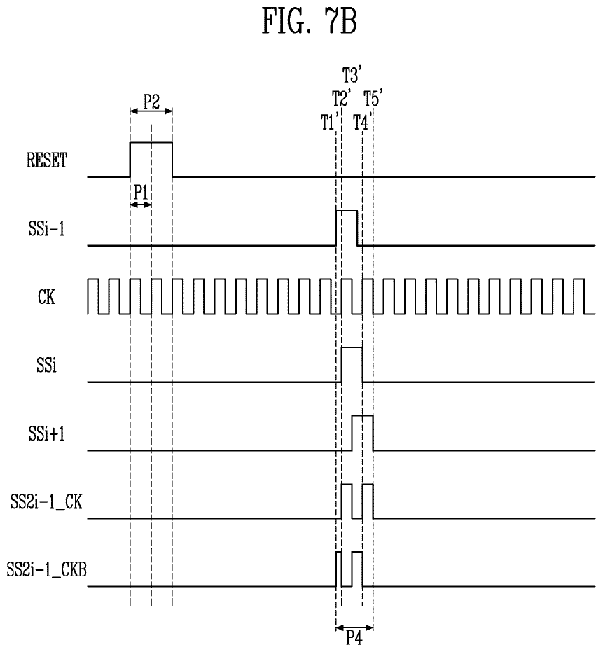

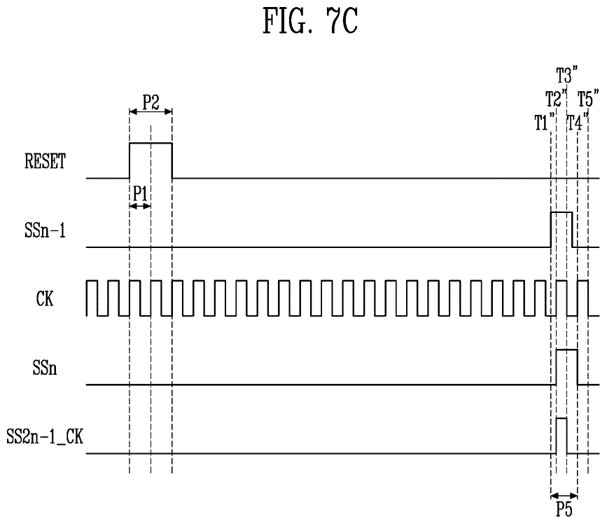

In contrast, according to embodiments of the present invention, among the plurality of stages ST, a masked clock signal CK may be provided to stages ST excluding stages ST that output the data signal SS. Accordingly, unintentional waste of power consumption occurring in the stages ST can be prevented. Details will be described later with reference to FIGS. 7A to 7C.

Referring to FIG. 5, the first stage ST1 may supply the first data signal SS1 to the first data line DL1 in response to the start signal DSP and the first output clock signal SS1_CK.

The second stage ST2 may supply the second data signal SS2 to the second data line DL2 in response to a first carry signal CR1 and the first inverted output clock signal SS1_CKB from the first stage ST1.

The third stage ST3 may supply the third data signal SS3 to the third data line DL3 in response to a second carry signal CR2 and a second output clock signal SS2_CK from the second stage ST2.

The fourth stage ST4 may suppl the fourth data signal SS4 to the fourth data line DL4 in response to a third carry signal CR3 and a second inverted output clock signal SS2_CKB from the third stage ST3.

The odd-numbered stage ST may be driven in response to a carry signal CR (or start signal DSP) of a previous stage and an output clock signal (for example, the first output clock signal SS1_CK). The even-numbered stage may be driven in response to a carry signal CR of a previous stage and an inverted output clock signal (for example, the first inverted output clock signal SS1_CKB).

The stages ST1 to STn may receive a reset signal RESET. In this case, the reset signal RESET may be supplied when a power source is input or at each frame period. In an example in which the reset signal RESET is supplied to the stages ST1 to STn, the stages ST1 to STn may be initialized.

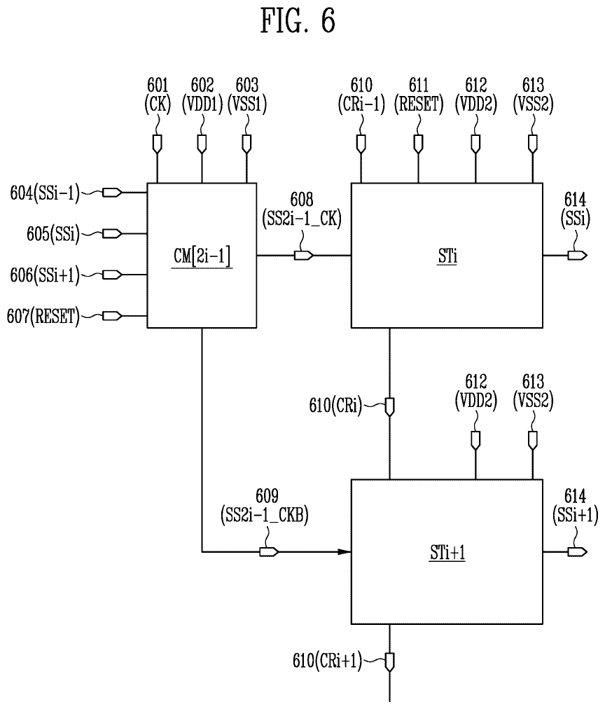

FIG. 6 is a diagram illustrating an embodiment of connection terminals of a stage and a masking circuit illustrated in FIG. 5. In FIG. 6, for convenience of description, an embodiment of an i-th stage, an (i+1)th stage, and a (2i−1)th masking circuit are illustrated. However, the present invention is not limited thereto. In this case, i may be a natural number greater than or equal to 1 and less than or equal to n.

Referring to FIG. 6, a (2i−1)th masking circuit CM[2i−1] may include a first input terminal 601, a first power source input terminal 602, a second power source input terminal 603, a second input terminal 604, a third input terminal 605, a fourth input terminal 606, a fifth input terminal 607, a first output terminal 608, and a second output terminal 609.

The first input terminal 601 may receive a clock signal CK. The first power source input terminal 602 may receive a first power source voltage VDD1.

An (i−1)th data signal SSi−1 output from an (i−1)th stage may be input to the second input terminal 604. An i-th data signal SSi output from an i-th stage STi may be input to the third input terminal 605. An (i+1)th data signal SSi+1 output from an (i+1) h stage STi+1 may be input to the fourth input terminal 606.

The first power source input terminal 602 may receive the first power source voltage VDD1. The second power source input terminal 603 may receive a second power source voltage VSS1. Here, the second power source voltage VSS1 may be set to a lower voltage than the first power source voltage VDD1. In some aspects, in an embodiment, the first power source voltage VDD1 may be set to a gate-on voltage associated with turning on transistors. The second power source voltage VSS1 may be set to a gate-off voltage associated with turning off transistors.

The fifth input terminal 607 may receive a reset signal RESET. The reset signal RESET may be a signal for initializing the masking circuit CM (see FIG. 5) and the stages ST (see FIG. 5), and may be supplied more than once when a power source is input. In an embodiment, the reset signal RESET may be supplied every frame period.

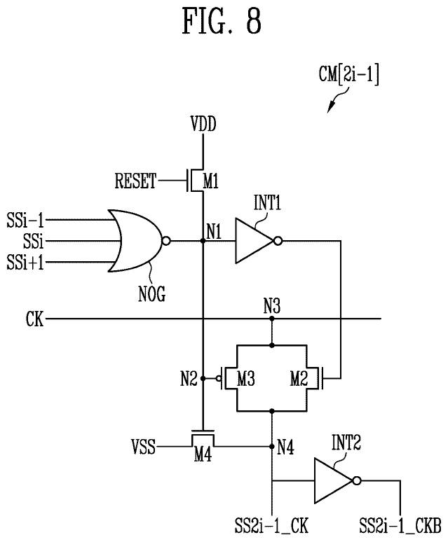

The first output terminal 608 may output an i-th output clock signal SSi_CK to the i-th stage STi. The second output terminal 609 may output an i-th inverted output clock signal SSi_CKB to the (i+1)th stage STi+1. Here, the i-th inverted output clock signal SSi_CKB may be a signal in which the phase of the i-th output clock signal SSi_CK is inverted in at least some sections. Details will be described later with reference to FIG. 8.

Each of the stages ST may include a sixth input terminal 610, a seventh input terminal 611, a third power source input terminal 612, a fourth power source input terminal 613, and a third output terminal 614.

The sixth input terminal 610 may receive a carry signal CR (see FIG. 5) of a previous stage. For example, an (i−1)th carry signal CRi−1 may be input to the sixth input terminal 610 of the i-th stage STi, and an i-th carry signal CRi may be input to the sixth input terminal 610 of the (i+1)th stage STi+1. Here, when the i-th stage STi is set as a first stage (that is, the first stage ST1 (see FIG. 5)), a start signal DSP may be input to the sixth input terminal 610.

The seventh input terminal 611 may receive the reset signal RESET. The reset signal RESET may be a signal for initializing the stages STi and STi+1, and may be supplied more than once when the power source is input. The reset signal RESET may be supplied every frame period. According to an embodiment, the reset signal RESET may be the same as the reset signal RESET supplied to the (2i−1)th masking circuit CM[2i−1]. However, the present invention is not limited thereto.

A third power source voltage VDD2 may be supplied to the third power source input terminal 612 of the stages STi and STi+1. A fourth power source voltage VSS2 may be supplied to the fourth power source input terminal 613. Here, the fourth power source voltage VSS2 may be set to a lower voltage than the third power source voltage VDD2. According to an embodiment, the third power source voltage VDD2 and the fourth power source voltage VSS2 may be the same as the first power source voltage VDD1 and the second power source voltage VSS1, but the present invention is not limited thereto.

The third output terminal 614 may output data signals SSi and SSi+1 of the stages STi and STi+1, respectively. In this case, the i-th data signal SSi may be supplied to an i-th data line DLi, and the (i+1)th data signal SSi+1 may be supplied to an (i+1)th data line DLi+1.

FIGS. 7A to 7C are diagrams illustrating an embodiment of a method of driving the data driver of FIG. 5.

In FIG. 7A, signals related to the first masking circuit CM1, the first stage ST1, and the second stage ST2 of FIG. 5 are illustrated. In FIG. 7B, signals related to the (2i−1)th masking circuit CM[2i−1], the (i−1)th stage STi−1, the i-th stage STi, and the (i+1)th stage STi+1 of FIG. 5 are illustrated. In FIG. 7C, signals related to the (2n−1)th masking circuit CM[2n−1], the (n−1)th stage, and the n-th stage STi of FIG. 5 are illustrated.

First, referring to FIGS. 5 and 7A, the reset signal RESET may be input to the first masking circuit CM1, the first stage ST1, and the second stage ST2. In this case, the reset signal RESET may be a signal of a logic high level during a second section P2, and may be a signal of a logic low level during the remaining sections. That is, during the second section P2, the first masking circuit CM1, the first stage ST1, and the second stage ST2 may be initialized. The term “section” described herein may refer to a time period.

The clock signal CK may be input to the first masking circuit CM1. In this case, the clock signal CK may have a waveform that repeats a logic high level and a logic low level at a predetermined cycle. For example, the clock signal CK may be a signal having a cycle of a first section P1 and a waveform that repeats a logic high level and a logic low level. Expressed another way, the clock signal CK may be a signal having a cycle duration equal to a duration of the first section P1, and the waveform of the clock signal CK may alternate between a logic high level and a logic low level during each cycle duration.

The start signal DSP may be at a logic low level during a section before a first time point T1. The start signal DSP may transition from the logic low level to a logic high level at the first time point T1. Thereafter, the start signal DSP may transition from the logic high level to the logic low level between a third time point T3 and a fourth time point T4.

The first data signal SS1 may be a signal of a logic low level during a section before a second time point T2. The first data signal SS1 may transition from the logic low level to a logic high level at the second time point T2. Thereafter, the first data signal SS1 may transition from the logic high level to the logic low level at the fourth time point T4.

The second data signal SS2 may be a signal of a logic low level during a section before the third time point T3. The second data signal SS2 may transition from the logic low level to a logic high level at the third time point T3. Thereafter, the second data signal SS2 may transition from the logic high level to the logic low level at a fifth time point T5.

In this case, the first data signal SS1 and the second data signal SS2 may be data signals SS output from the first stage ST1 and the second stage ST2, respectively. In some aspects, the first output clock signal SS1_CK and the first inverted output clock signal SS1_CKB may be signals output from the first masking circuit CM1.

The first output clock signal SS1_CK may have a signal of a logic low level during a section before the second time point T2. The first output clock signal SS1_CK may transition from the logic low level to a logic high level at the second time point T2. The first output clock signal SS1_CK may maintain the logic high level between the second time point T2 and the third time point T3. Thereafter, the first output clock signal SS1_CK may transition from the logic high level to the logic low level at the third time point T3. The first output clock signal SS1_CK may maintain the logic low level between the third time point T3 and the fourth time point T4. The first output clock signal SS1_CK may transition from the logic low level to the logic high level at the fourth time point T4. The first output clock signal SS1_CK may maintain the logic high level between the fourth time point T4 and the fifth time point T5. The first output clock signal SS1_CK may transition from the logic high level to the logic low level at the fifth time point T5. The first output clock signal SS1_CK may maintain the logic low level during a section after the fifth time point T5.

The first inverted output clock signal SS1_CKB may have a signal of a logic low level during a section before the first time point T1. The first inverted output clock signal SS1_CKB may transition from the logic low level to a logic high level at the second time point T2. The first inverted output clock signal SS1_CKB may maintain the logic high level between the first time point T1 and the second time point T2. Thereafter, the first inverted output clock signal SS1_CKB may transition from the logic high level to the logic low level at the second time point T2. The first inverted output clock signal SS1_CKB may maintain the logic low level between the second time point T2 and the third time point T3. The first inverted output clock signal SS1_CKB may transition from the logic low level to the logic high level at the third time point T3. The first inverted output clock signal SS1_CKB may maintain the logic high level between the third time point T3 and the fourth time point T4. The first inverted output clock signal SS1_CKB may transition from the logic high level to the logic low level at the fourth time point T4. The first inverted output clock signal SS1_CKB may maintain the logic low level during a section after the fourth time point T4.

According to an embodiment of the present invention, the first masking circuit CM1 may mask the clock signal CK during the remaining sections except for a third section P3. In this case, the third section P3 may include a section in which a stage (for example, the first stage ST1) to which the first masking circuit CM1 is connected and an adjacent stage (for example, the second stage ST2) output data signals SS. For example, the first output clock signal SS1_CK during the third section P3 may be the same as the clock signal CK during the third section P3. That is, the first masking circuit CM1 may output the first output clock signal SS1_CK that is the same as the clock signal CK by refraining from masking the clock signal CK during the third section P3.

In some aspects, the first inverted output clock signal SS1_CKB during the third section P3 may be a signal in which the phase of the clock signal CK during the third section P3 is inverted. That is, the first masking circuit CM1 may output the first inverted output clock signal SS1_CKB in which the phase of the clock signal CK is inverted without masking the clock signal CK during the third section P3. In other words, in some embodiments, the first masking circuit CM1 may drive the first stage ST1 and the second stage ST2 in the third section P3, and the first masking circuit CM1 may refrain from driving the first stage ST1 and the second stage ST2 in sections other than the third section P3. For example, during sections other than the third section P3, at least one transistor included in the first stage ST1 and the second stage ST2 may not be turned on and/or turned off, and unintentional wasted power consumption can be minimized.

Referring to FIGS. 5, 6, and 7B, during the second section P2, the reset signal RESET may be input to the (2i−1)th masking circuit CM[2i−1], the (i−1)th stage, the i-th stage STi, and the (i+1)th stage STi+1. Accordingly, during the second section P2, the method may include initializing the (2i−1)th masking circuit CM[2i−1], the (i−1)th stage, the i-th stage STi, and the (i+1)th stage STi+1.

The clock signal CK may be input to the (2i−1)th masking circuit CM[2i−1]. The reset signal RESET and the clock signal CK of FIG. 7B may be explained similarly to the reset signal RESET and the clock signal CK of FIG. 7A. Hereinafter, overlapping descriptions will be omitted.

The (i−1)th data signal SSi−1 may be at a logical low level during a section before a first time point T1′. The (i−1)th data signal SSi−1 may transition from the logic low level to a logic high level at the first time point T1′. Thereafter, the (i−1)th data signal SSi−1 may transition from the logic high level to the logic low level between a third time point T3′ and a fourth time point T4′.

The i-th data signal SSi may be a signal of a logic low level during a section before a second time point T2′. The i-th data signal SSi may transition from the logic low level to a logic high level at the second time point T2′. Thereafter, the i-th data signal SSi may transition from the logic high level to the logic low level at the fourth time point T4′.

The (i+1)th data signal SSi+1 may be a signal of a logic low level during a section before the third time point T3′. The (i+1)th data signal SSi+1 may transition from the logic low level to a logic high level at the third time point T3′. Thereafter, the (i+1)th data signal SSi+1 may transition from the logic high level to the logic low level at a fifth time point T5′.

In this case, the (i−1)th data signal SSi−1, the i-th data signal SSi, and the (i+1)th data signal SSi+1 may be data signals SS output from the (i−1)th stage STi−1, the i-th stage Sti, and the (i+1)th stage STi+1, respectively. In some aspects, a (2i−1)th output clock signal SS2i−1_CK and a (2i−1)th inverted output clock signal SS2i−1_CKB may be signals output from the (2i−1)th masking circuit CM[2i−1].

The (2i−1)th output clock signal SS2i−1_CK may have a signal of a logic low level during a section before the second time point T2′. The (2i−1)th output clock signal SS2i−1_CK may transition from the logic low level to a logic high level at the second time point T2′. The (2i−1)th output clock signal SS2i−1_CK may maintain the logic high level between the second time point T2′ and the third time point T3′. Thereafter, the (2i−1)th output clock signal SS2i−1_CK may transition from the logic high level to the logic low level at the third time point T3′. The (2i−1)th output clock signal SS2i−1_CK may maintain the logic low level between the third time point T3′ and the fourth time point T4′. The (2i−1)th output clock signal SS2i−1_CK may transition from the logic low level to the logic high level at the fourth time point T4′. The (2i−1)th output clock signal SS2i−1_CK may maintain the logic high level between the fourth time point T4′ and the fifth time point T5′. The (2i−1)th output clock signal SS2i−1_CK may transition from the logic high level to the logic low level at the fifth time point T5′. The (2i−1)th output clock signal SS2i−1_CK may maintain the logic low level during a section after the fifth time point T5′.

The (2i−1)th inverted output clock signal SS2i−1_CKB may have a signal of a logic low level during a section before the first time point T1′. The (2i−1)th inverted output clock signal SS2i−1_CKB may transition from the logic low level to a logic high level at the second time point T2′. The (2i−1)th inverted output clock signal SS2i−1_CKB may maintain the logic high level between the first time point T1′ and the second time point T2′. Thereafter, the (2i−1)th inverted output clock signal SS2i−1_CKB may transition from the logic high level to the logic low level at the second time point T2′. The (2i−1)th inverted output clock signal SS2i−1_CKB may maintain the logic low level between the second time point T2′ and the third time point T3′. The (2i−1)th inverted output clock signal SS2i−1_CKB may transition from the logic low level to the logic high level at the third time point T3′. The (2i−1)th inverted output clock signal SS2i−1_CKB may maintain the logic high level between the third time point T3′ and the fourth time point T4′. The (2i−1)th inverted output clock signal SS2i−1_CKB may transition from the logic high level to the logic low level at the fourth time point T4′. The (2i−1)th inverted output clock signal SS2i−1_CKB may maintain the logic low level during a section after the fourth time point T4′.

According to an embodiment of the present invention, the (2i−1)th masking circuit CM[2i−1] may mask the clock signal CK during the remaining sections except for a fourth section P4. In this case, the fourth section P4 may include a section in which a stage (for example, the i-th stage STi) to which the (2i−1)th masking circuit CM[2i−1] is connected and adjacent stages (for example, the (i−1)th stage STi−1 and the (i+1)th stage STi+1) output data signals SS. For example, the (2i−1)th output clock signal SS2i−1_CK during the fourth section P4 may be the same as the clock signal CK during the fourth section P4. That is, the (2i−1)th masking circuit CM[2i−1] may output the (2i−1)th output clock signal SS2i−1_CK that is same as the clock signal CK without masking the clock signal CK during the fourth section P4.

In some aspects, the (2i−1)th inverted output clock signal SS2i−1_CKB during the fourth section P4 may be a signal in which the phase of the clock signal CK during the fourth section P4 is inverted. That is, the (2i−1)th masking circuit CM[2i−1] may output the (2i−1)th inverted output clock signal SS2i−1_CKB in which the phase of the clock signal CK is inverted without masking the clock signal CK during the fourth section P4. In other words, in some embodiments, the (2i−1)th masking circuit CM[2i−1] may drive the i-th stage STi and the (i+1)th stage STi+1 in the fourth section P4, and the (2i−1)th masking circuit CM[2i−1] may refrain from driving the i-th stage STi and the (i+1)th stage STi+1 in sections other than the fourth section P4. For example, during sections other than the fourth section P4, at least one transistor included in the i-th stage STi and the (i+1)th stage STi+1 may not be turned on and/or turned off, and unintentionally wasted power consumption can be minimized.

Referring to FIGS. 5, 6, and 7C, during the second section P2, the reset signal RESET may be input to the (2n−1)th masking circuit CM[2n−1], the (n−1) h stage, and the n-th stage STn. Accordingly, during the second section P2, the (2n−1)th masking circuit CM[2n−1], the (n−1)th stage STn−1, and the n-th stage STn may be initialized.

The clock signal CK may be input to the (2n−1)th masking circuit CM[2n−1]. The reset signal RESET and the clock signal CK of FIG. 7B may be explained similarly to the reset signal RESET and the clock signal CK of FIG. 7A. Hereinafter, overlapping descriptions will be omitted.

The (n−1)th data signal SSn−1 may be at a logical low level during a section before a first time point T1″. The (n−1)th data signal SSn−1 may transition from the logic low level to a logic high level at the first time point T1″. Thereafter, the (n−1)th data signal SSn−1 may transition from the logic high level to the logic low level between a third time point T3″ and a fourth time point T4″.

The n-th data signal SSn may be a signal of a logic low level during a section before a second time point T2″. The n-th data signal SSn may transition from the logic low level to a logic high level at the second time point T2″. Thereafter, the n-th data signal SSn may transition from the logic high level to the logic low level at the fourth time point T4″.

In this case, the (n−1)th data signal SSn−1 and the n-th data signal SSn may be data signals SS output from the (n−1)th stage STn−1 and the n-th stage STn, respectively. In some aspects, a (2n−1)th output clock signal SS2n−1_CK may be a signal output from the (2n−1)th masking circuit CM[2n−1].

The (2n−1)th output clock signal SS2n−1_CK may have a signal of a logic low level during a section before the second time point T2″. The (2n−1)th output clock signal SS2n−1_CK may transition from the logic low level to a logic high level at the second time point T2″. The (2n−1)th output clock signal SS2n−1_CK may maintain the logic high level between the second time point T2″ and the third time point T3″. Thereafter, the (2i−1)th output clock signal SS2i−1_CK may transition from the logic high level to the logic low level at the third time point T3″. The (2i−1)th output clock signal SS2i−1_CK may maintain the logic low level during a section after the third time point T3″.

According to an embodiment of the present invention, the (2n−1)th masking circuit CM[2n−1] may mask the clock signal CK during the remaining sections except for a fifth section P5. In this case, the fifth section P5 may include a section in which a stage (for example, the n-th stage STn) to which the (2n−1)th masking circuit CM[2n−1] is connected and an adjacent stage (for example, the (n−1)th stage) output data signals SS. For example, the (2n−1)th output clock signal SS2n−1_CK during the fifth section P5 may be the same as the clock signal CK during the fifth section P5. That is, the (2n−1)th masking circuit CM[2n−1] may output the (2n−1)th output clock signal SS2n−1_CK that is the same as the clock signal CK without masking the clock signal CK during the fifth section P5. Accordingly, the (2n−1)th masking circuit CM[2n−1] may drive the n-th stage STn in the fifth section P5, and the (2n−1)th masking circuit CM[2n−1] may refrain from driving the n-th stage STn in sections other than the fifth section P5. For example, during sections other than the fifth section P5, at least one transistor included in the n-th stage STn may not be turned on and/or turned off, and unintentionally wasted power consumption can be minimized.

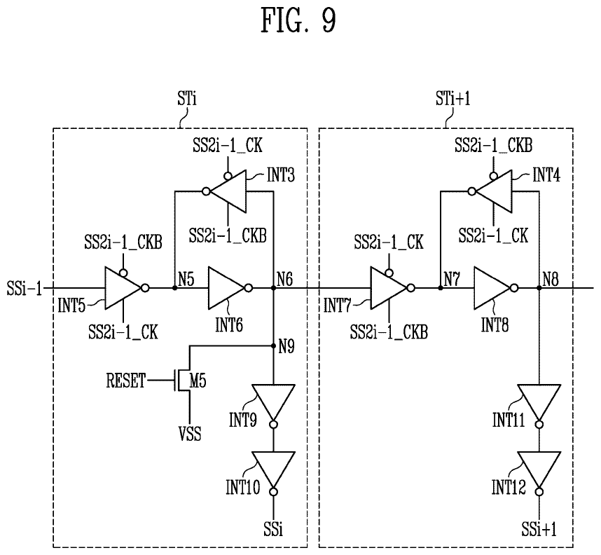

FIG. 8 is a diagram illustrating components of a (2i−1)th masking circuit of FIG. 6. FIG. 9 is a circuit diagram illustrating components of an i-th stage and an (i+1)th stage of FIG. 6.

In FIG. 8, the (2i−1)th masking circuit CM[2i−1] is mainly described, but the present invention is not limited thereto. For example, the first to (2n−1)th masking circuits CM1 to CM[2n−1] can also be described similarly. In some aspects, in FIG. 9, the i-th stage STi and the (i+1)th stage STi+1 are described, but the present invention is not limited thereto. For example, the first to n-th stages ST1 to STn can also be described similarly.

Referring to FIG. 8, the (2i−1)th masking circuit CM[2i−1] may include a first transistor M1, a second transistor M2, a third transistor M3, a fourth transistor M4, a first inverter INT1, a second inverter INT2, and a logic operation unit NOG.

The first transistor M1 may output a first power source voltage VDD to a first node N1 in response to the reset signal RESET. For example, the first transistor M1 may include an electrode connected to the first power source voltage VDD, another electrode connected to the first node N1, and a gate electrode connected to the reset signal RESET. In this case, the first power source voltage VDD may be the same as the first power source voltage VDD1 of FIG. 6.

The second transistor M2 may output the clock signal CK to a fourth node N4 in response to a signal output through the logic operation unit NOG and the first inverter INT1. For example, the second transistor M2 may include an electrode connected to a third node N3 to which the clock signal CK is supplied, another electrode connected to the fourth node N4, and a gate electrode connected to an output terminal of the first inverter INT1. In this case, the second transistor M2 may be an N-type transistor. That is, when a signal of a logic high level is applied to the gate electrode, the second transistor M2 may be turned on.

The third transistor M3 may output the clock signal CK to the fourth node N4 in response to a voltage of a second node N2. For example, the third transistor M3 may include an electrode connected to the third node N3 to which the clock signal CK is supplied, another electrode connected to the fourth node N4, and a gate electrode connected to the second node N2. In this case, the third transistor M3 may be a P-type transistor. That is, when a signal of a logic low level is applied to the gate electrode, the third transistor M3 may be turned on.

The fourth transistor M4 may output a second power source voltage VSS to the fourth node N4 in response to the voltage of the second node N2. For example, the fourth transistor M4 may include an electrode connected to the second power source voltage VSS, another electrode connected to the fourth node N4, and a gate electrode connected to the second node N2. In this case, the second power source voltage VSS may be the same as the second power source voltage VSS1 of FIG. 6. In this case, the fourth transistor M4 may be an N-type transistor. That is, when a signal of a logic high level is applied to the gate electrode, the fourth transistor M4 may be turned on.

The first inverter INT1 may invert an output signal of the logic operation unit NOG supplied to the first node N1. In other words, when the output signal of the logic operation unit NOG is at a logic high level, the first inverter INT1 may output a signal of a logic low level. For example, the first inverter INT1 may include an input terminal connected to the first node N1 and an output terminal connected to the gate electrode of the second transistor M2.

The second inverter INT2 may invert a signal supplied to the fourth node N4. For example, the second inverter INT2 may output the (2i−1)th inverted output clock signal SS2i−1_CKB having a waveform in which the phase of the (2i−1)th output clock signal SS2i−1_CK is inverted.

The logic operation unit NOG may receive an (i−1)th output signal SSi−1, an i-th output signal SSi, and an (i+1)th output signal SSi+1. In the example described with reference to FIG. 8, the logic operation unit NOG may be driven as a NOR gate. For example, the logical operation unit NOG may be a logic NOR gate capable of performing logical NOR operations, but embodiments of the present disclosure are not limited thereto. For example, the logical operation unit NOG may be any logic gate capable of outputting a logic signal suitable for operation of the (2i−1)th masking circuit CM[2i−1] in accordance with embodiments of the present disclosure. However, embodiments of the present invention are not limited thereto. In an example in which any one of the (i−1)th output signal SSi−1, the i-th output signal SSi, and the (i+1)th output signal SSi+1 is at a logic high level, the logic operation unit NOG may output a signal of a logic low level. A section in which the logic operation unit NOG outputs the signal of the logic low level may correspond to the fourth section P4 of FIG. 7B. In this case, the signal of the logic low level may be changed to a signal of a logic high level through the first inverter INT1, and the signal of the logic high level may be transmitted to the gate electrode of the second transistor M2. Accordingly, the second transistor M2 may be turned on, and the clock signal CK supplied to the third node N3 may be supplied to the fourth node N4.

In some embodiments, when the (i−1)th output signal SSi−1, the i-th output signal SSi, and the (i+1)th output signal SSi+1 are all at the logic low level, the logic operation unit NOG may output a signal of the logic high level. A section in which the logic operation unit NOG outputs the signal of the logic high level may correspond to the sections except for the fourth section P4 of FIG. 7B. In this case, the signal of the logic high level may be changed to a signal of the logic low level through the first inverter INT1. The signal of the logic low level may be transmitted to the gate electrode of the second transistor M2. Accordingly, the second transistor M2 may be turned off, and the clock signal CK may not be supplied to the fourth node N4. In this case, the gate electrode of the fourth transistor M4 may be turned on in response to receiving the signal of the logic high level. Accordingly, the second power source voltage VSS may be supplied to the fourth node N4, and an output terminal of the (2i−1)th masking circuit CM[2i−1] may not be floating.

Referring to FIG. 9, the i-th stage STi may include a third inverter INT3, a fifth inverter INT5, a sixth inverter INT6, a ninth inverter INT9, a tenth inverter INT10, and a fifth transistor M5. The (i+1)th stage STi+1 may include a fourth inverter INT4, a seventh inverter INT7, an eighth inverter INT8, an eleventh inverter INT11, and a twelfth inverter INT12. The fourth inverter INT4, the seventh inverter INT7, the eighth inverter INT8, the eleventh inverter INT11, and the twelfth inverter INT12 of the (i+1)th stage STi+1 may be described similarly to the third inverter INT3, the fifth inverter INT5, the sixth inverter INT6, the ninth inverter INT9, and the tenth inverter INT10 of the i-th stage STi. Hereinafter, the i-th stage STi will be mainly described.

The third inverter INT3 and the fifth inverter INT5 may be implemented as three-state inverters. In this case, the fifth inverter INT5 may receive the (i−1)th data signal SSi−1 as an input signal and the (2i−1)th output clock signal SS2i−1_CK as an enable signal. Accordingly, when the fifth inverter INT5 receives the (2i−1)th output clock signal SS2i−1_CK of a logic low level as an enable signal, a fifth node N5 may be in a floating state. Accordingly, the fifth node N5, a sixth node N6, and a ninth node N9 may be in a floating state. In this case, in order to prevent the continuous floating state of the fifth node N5, the sixth node N6, and the ninth node N9, the fifth transistor M5 may supply the second power source voltage VSS to the ninth node N9 in response to the reset signal RESET. Accordingly, the fifth node N5, the sixth node N6, and the ninth node N9 may be initialized.

When the (2i−1)th output clock signal SS2i−1_CK is at the logic high level and the (i−1)th data signal SSi−1 is at the logic low level, the fifth inverter INT5 may output a signal of the logic high level. Furthermore, when the (2i−1)th output clock signal SS2i−1_CK is at the logic high level and the (i−1)th data signal SSi−1 is at the logic high level, the fifth inverter INT5 may output a signal of the logic low level.

The third inverter INT3 may receive a signal supplied to the sixth node N6 and receive the (2i−1)th inverted output clock signal SS2i−1_CKB as an enable signal. Accordingly, the third inverter INT3 may be in a floating state when the (2i−1)th inverted output clock signal SS2i−1_CKB is at the logic low level. In some aspects, when the (2i−1)th inverted output clock signal SS2i−1_CKB is at the logic high level and the signal supplied to the sixth node N6 is at the logic low level, the third inverter INT3 may output a signal of the logic high level. Furthermore, when the (2i−1)th inverted output clock signal SS2i−1_CKB is at the logic high level and the signal supplied to the sixth node N6 is at the logic high level, the fifth inverter INT5 may output a signal of the logic low level.

The sixth inverter INT6 may receive a signal of the fifth node N5, invert the signal, and output the signal to the sixth node N6. In an example in which the signal of the fifth node N5 is at the logic high level, the sixth inverter INT6 may output a signal of the logic low level to the sixth node N6.

The ninth inverter INT9 and the tenth inverter INT10 may be configured as transmission gates. For example, a signal applied to the ninth node N9 may be supplied to the data line DL (see FIG. 1) (for example, the i-th data line) as the i-th data signal SSi.

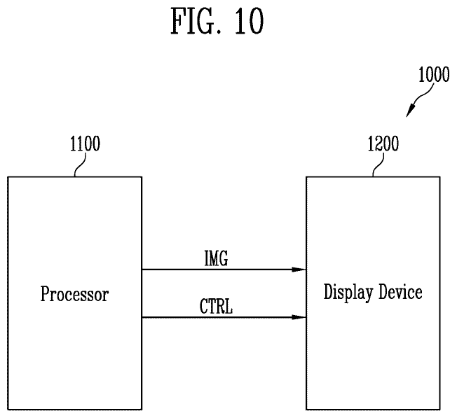

FIG. 10 is a block diagram illustrating an embodiment of a display system.

Referring to FIG. 10, a display system 1000 may include a processor 1100 and a display device 1200.

The processor 1100 may perform various tasks and calculations. In some embodiments, the processor 1100 may include an application processor, a graphics processor, a microprocessor, a central processing unit (CPU), and the like. The processor 1100 may be connected to and control other components of the display system 1000 through a bus system.

The processor 1100 may transmit image data IMG and a control signal CTRL to the display device 1200. The display device 1200 may display an image based on the image data IMG and the control signal CTRL. The display device 1200 may be configured similarly to the display device DD described with reference to FIG. 1. In this case, the image data IMG and the control signal CTRL may be provided as the input image data IMG and the control signal CTRL of FIG. 1, respectively.

The display system 1000 may include a computing system that provides an image display function, such as, for example, a smart watch, a mobile phone, a smart phone, a portable computer, a tablet personal computer, a watch phone, an automotive display, smart glasses, a portable multimedia player (PMP), a navigation, and an ultra mobile personal computer (UMPC). In some aspects, the display system 1000 may include at least one of a head-mounted display (HMD) device, a virtual reality (VR) device, a mixed reality (MR) device, and an augmented reality (AR) device.

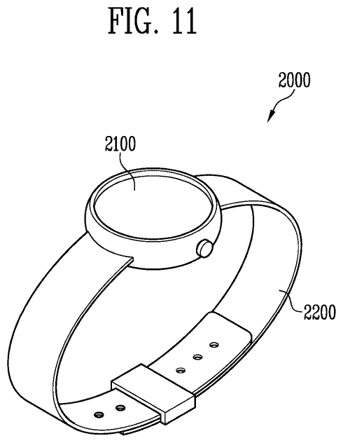

FIGS. 11 to 14 are perspective views illustrating application examples of the display system of FIG. 10.

Referring to FIG. 11, the display system 1000 of FIG. 10 may be applied to a smart watch 2000 including a display unit 2100 and a strap unit 2200.

The smart watch 2000 may be a wearable electronic device. For example, the smart watch 2000 may have a structure in which the strap unit 2200 is mounted on a user's wrist. Here, the display system 1000 and/or the display device 1200 may be applied to the display unit 2100 and provide image data including time information to the user.

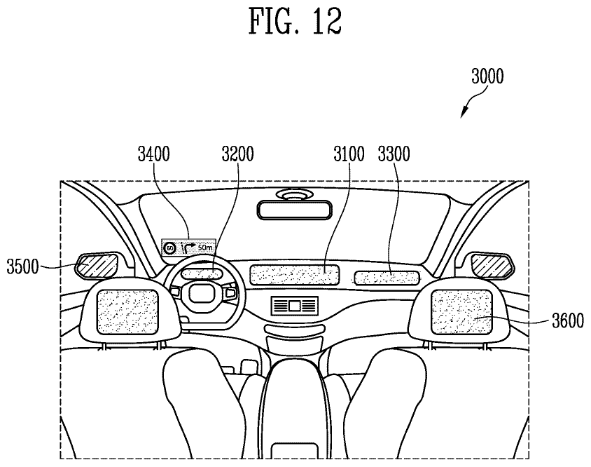

Referring to FIG. 12, the display system 1000 of FIG. 10 may be applied to an automotive display system 3000. Here, the automotive display system 3000 may include a computing system provided inside and/or outside a vehicle and capable of providing image data.

For example, the display system 1000 and/or the display device 1200 may be applied to at least one of an infotainment panel 3100, a cluster 3200, a co-driver display 3300, a head-up display 3400, a side mirror display 3500, and a rear seat display 3600 provided in a vehicle.

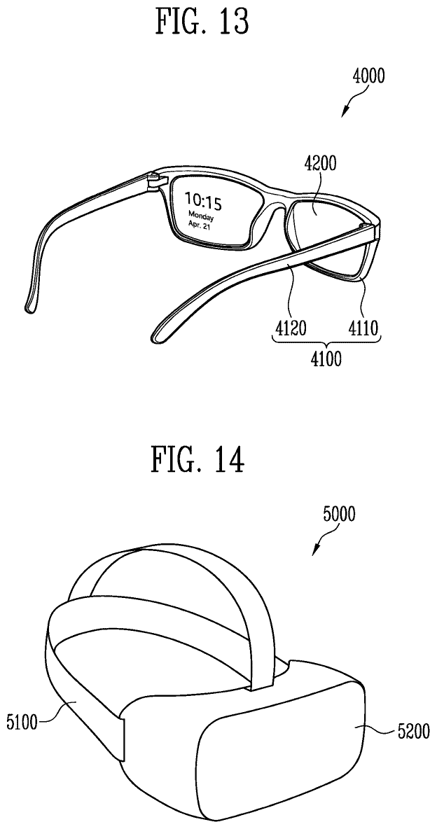

Referring to FIG. 13, the display system 1000 of FIG. 10 may be applied to smart glasses 4000. The smart glasses 4000 may be a wearable electronic device that can be worn on a user's head. For example, the smart glasses 4000 may be a wearable device for augmented reality.

The smart glasses 4000 may include a frame 4100 and a lens unit 4200. The frame 4100 may include a housing 4110 that supports the lens unit 4200 and a leg unit 4120 that the user wears. The leg unit 4120 may be connected to the housing 4110 through a hinge and can be folded or unfolded relative to the housing 4110.

A battery, a touch pad, a microphone, a camera, and the like may be built into the frame 4100. In some aspects, a projector that outputs light, a processor that controls light signals, and the like may be built into the frame 4100.

The lens unit 4200 may include an optical member that transmits or reflects light. For example, the lens unit 4200 may include glass, transparent synthetic resin, or the like.

An image generated by an optical signal transmitted from the projector of the frame 4100 is reflected on a back surface (for example, a side facing the user's eyes) of the lens unit 4200, allowing the user's eyes to recognize visual information. For example, the user may recognize visual information such as, for example, time and date displayed on the lens unit 4200. In this case, the projector and/or the lens unit 4200 may be a type of display device. The display device 1200 may be applied to the projector and/or the lens unit 4200.

Referring to FIG. 14, the display system 1000 of FIG. 10 may be applied to a head-mounted display device 5000.

The head-mounted display device 5000 may be a wearable electronic device that can be worn on a user's head. For example, the head-mounted display device 5000 may be a wearable device for virtual reality or mixed reality.

The head-mounted display device 5000 may include a head mounting band 5100 and a display device storage case 5200. The head mounting band 5100 may be connected to the display device storage case 5200. The head mounting band 5100 may include a horizontal band and/or a vertical band for fixing the head-mounted display device 5000 to the user's head. The horizontal band may be configured to surround the side of the user's head, and the vertical band may be configured to surround the top of the user's head. However, embodiments of the present invention are not limited thereto. For example, the head mounting band 5100 may be implemented in the form of glasses frames, helmets, or the like.

The display device storage case 5200 may accommodate the display system 1000 and/or the display device 1200.

According to a display device and an electronic device of the present invention, unintentionally wasted power consumption can be minimized by masking at least a portion of a clock signal supplied to shift registers.

Effects according to the embodiments are not limited by the above-described contents, and more various other effects are included in the present specification.

Although specific embodiments and implementations have been described herein, other embodiments and modifications may be derived from the foregoing descriptions. Accordingly, the spirit of the present disclosure is not limited to the foregoing embodiments, but may also be applied to the claims set forth below, various obvious modifications, and equivalents.

What is claimed is:

1. A display device comprising:
a controller configured to generate a start signal and a clock signal;
a masking circuit configured to generate output clock signals by masking at least a portion of the clock signal; and
a plurality of stages configured to receive an output clock signal of the output clock signals in response to the start signal and output a data signal,
wherein the masking circuit is configured to receive data signals respectively output from a stage of the plurality of stages and at least one other stage disposed adjacent to the stage.

2. The display device of claim 1, wherein the plurality of stages comprise a first stage and a second stage following the first stage, and
wherein the masking circuit comprises a first masking circuit configured to receive the start signal, a first data signal output from the first stage, and a second data signal output from the second stage.

3. The display device of claim 2, wherein the first masking circuit is configured to:
supply a first output clock signal to the first stage, and
supply a second output clock signal different from the first output clock signal to the second stage.

4. The display device of claim 3, wherein the first masking circuit is configured to:
supply the first output clock signal by refraining from masking the clock signal during a third section; and
supply the second output clock signal by masking the clock signal during sections different from the third section.

5. The display device of claim 4, wherein the first masking circuit is configured to supply the second output clock signal by inverting a phase of the first output clock signal during the third section, such that the second output clock signal has a waveform in which the phase of the first output clock signal during the third section is inverted.

6. The display device of claim 5, wherein the third section is from a first time point at which the start signal transitions from a logic low level to a logic high level to a fifth time point at which the second data signal transitions from the logic high level to the logic low level.

7. The display device of claim 3, wherein the clock signal has a cycle duration equal to a duration of a first section, and the clock signal alternates between a logic high level and a logic low level at each cycle duration.

8. The display device of claim 1, wherein the plurality of stages comprise an i-th stage, an (i−1)th stage preceding the i-th stage, and an (i+1)th stage following the i-th stage, and
wherein the masking circuit comprises an i-th masking circuit configured to receive an (i−1)th data signal output from the (i−1)th stage, an i-th data signal output from the i-th stage, and an (i+1)th data signal output from the (i+1)th stage.

9. The display device of claim 8, wherein the i-th masking circuit is configured to:
supply an i-th output clock signal to the i-th stage, and
supply an (i+1)th output clock signal different from the i-th output clock signal to the (i+1)th stage.

10. The display device of claim 9, wherein:
the i-th masking circuit is configured to:
supply the i-th output clock signal by refraining from masking the clock signal during a fourth section; and
supply the i-th output clock signal by masking the clock signal during sections different from the fourth section, and
the (i+1)th masking circuit is configured to supply the (i+1)th output clock signal by inverting a phase of the i-th output clock signal during the fourth section, such that wherein the (i+1)th output clock signal has a waveform in which the phase of the i-th output clock signal during the fourth section is inverted.

11. The display device of claim 10, wherein the fourth section is from a first time point at which the i-th data signal transitions from a logic low level to a logic high level to a fifth time point at which the (i+1)th data signal transitions from the logic high level to the logic low level.

12. The display device of claim 1, wherein the plurality of stages comprise an (n−1)th stage and an n-th stage following the (n−1)th stage, and
wherein the masking circuit comprises an n-th masking circuit configured to receive the start signal, an (n−1)th data signal output from the (n−1)th stage, and an n-th data signal output from the n-th stage.

13. The display device of claim 12, wherein the n-th masking circuit is configured to:
supply an n-th output clock signal to the n-th stage by refraining from masking the clock signal during a fifth section; and
supply an (n+1)th output clock signal by masking the clock signal during sections different from the fifth section.

14. The display device of claim 13, wherein the fifth section is from a first time point at which the (n−1)th data signal transitions from a logic low level to a logic high level to a fifth time point at which the n-th data signal transitions from the logic high level to the logic low level.

15. The display device of claim 1, wherein the masking circuit comprises:
a logic operation unit configured to receive an (i−1)th data signal, an i-th data signal, and an (i+1)th data signal;
a first inverter comprising an input terminal connected to a first node;
a first transistor comprising an electrode configured to receive a voltage from a first power source, another electrode connected to an output terminal of the logic operation unit, and a gate electrode configured to receive a reset signal;
an N-type second transistor comprising an electrode connected to a third node configured to receive the clock signal, another electrode connected to a fourth node, and a gate electrode connected to an output terminal of the first inverter; and
a P-type third transistor comprising an electrode connected to the third node, another electrode connected to the fourth node, and a gate electrode connected to the first node.

16. The display device of claim 15, wherein the masking circuit further comprises:
a fourth transistor comprising an electrode connected to a second power source having a lower voltage level than the first power source, another electrode connected to the fourth node, and a gate electrode connected to a second node, and
wherein when the first inverter outputs a signal of a logic low level, the fourth node receives a voltage from the second power source.

17. The display device of claim 16, wherein the masking circuit further comprises:
a second inverter comprising an input terminal connected to the fourth node, and
wherein when the first inverter outputs a signal of a logic high level, the second inverter outputs an i-th inverted output clock signal by inverting a phase of an i-th output clock signal output through the fourth node.

18. The display device of claim 17, wherein the masking circuit is configured to:
supply the i-th output clock signal to an i-th stage outputting the i-th data signal and comprised in the plurality of stages; and
supply the i-th inverted output clock signal to an (i+1)th stage outputting the (i+1)th data signal and comprised in the plurality of stages.

19. The display device of claim 15, wherein the logical operation unit comprises a NOR gate.

20. An electronic device comprising:
a display device configured to display an image based on input image data; and
a processor configured to provide the input image data to the display device,
wherein the display device comprises:
a controller configured to generate a start signal and a clock signal;
a masking circuit configured to generate output clock signals by masking at least a portion of the clock signal; and
a plurality of stages configured to receive an output clock signal of the output clock signals in response to the start signal and output a data signal,
wherein the masking circuit is configured to receive data signals respectively output from a stage of the plurality of stages and at least one other stage disposed adjacent to the stage.
